(19) United States
(12) Patent Application Publication
(10) Pub. No.: US 2025/0065347 A1
(43) Pub. Date: Feb. 27, 2025

(54) ATOMIZATION DEVICE

(71) Applicant: Panasonic Intellectual Property Management Co., Ltd., Osaka (JP)

(72) Inventors: DAISUKE TABATA, Osaka (JP); SHOGO FUJIMOTO, Tokyo (JP); TORU OKAZAKI, Osaka (JP); NAOFUMI HINO, Osaka (JP)

(21) Appl. No.: 18/947,042

(22) Filed: Nov. 14, 2024

Related U.S. Application Data
(63) Continuation of application No. PCT/JP2023/015609, filed on Apr. 19, 2023.

(30) Foreign Application Priority Data
May 25, 2022 (JP) 2022-085515

(51) Int. Cl. B05B 7/06; B05B 7/08

(52) U.S. Cl. CPC B05B 7/066; B05B 7/0861

(57) ABSTRACT

Gas-liquid ejector (50) includes atomization space (51) in which flow path (31) downstream of liquid flow path (21) is connected to a central part of an end surface of atomization space (51) on an upstream side, flow path (40) downstream of gas flow path (22) is connected to a circumference around the central part of the end surface of atomization space (51) on the upstream side, and flow path (40) downstream of gas flow path (22) has central axis (42) inclined from central axis (11) of flow path (31) downstream of liquid flow path (21).

### TECHNICAL FIELD

The present invention relates to an atomization device of a two-fluid nozzle type that atomizes liquid with gas.

### BACKGROUND ART

Nozzles for atomizing liquid are widely used for cooling a space or a substance, humidification, chemical liquid spraying such as for sterilization or a pleasant aromatic odor, space presentation, combustion, dust countermeasure, or the like. These atomization nozzles are roughly classified into a one-fluid nozzle that atomizes liquid by ejecting liquid from finer pores, and a two-fluid nozzle that atomizes liquid using gas such as air, nitrogen, or vapor. In comparison between the one-fluid nozzle and the two-fluid nozzle, the two-fluid nozzle is generally characterized by being superior in atomization performance to the one-fluid nozzle because the two-fluid nozzle atomizes liquid using energy of the gas.

This two-fluid nozzle is classified by a liquid supply method. One is a two-fluid nozzle of a liquid pressurization type that pressurizes liquid and feeds the liquid to a nozzle, and the other is a two-fluid nozzle of a suction type that generates negative pressure using compressed air passing through the inside of the nozzle to suck liquid.

Examples of the two-fluid nozzle of a suction type include a two-fluid nozzle of a suction type described in PTL 1.

As shown in FIG. 8, the two-fluid nozzle described in PTL 1 sucks water 83 injected from the center of each of second injection port 81 and third injection port 82 using compressed air 84 injected from an outer periphery, and injects not only the water by being finely atomized by shearing action of compressed air 84, but also compressed air 84 from first injection port 85. As described above, the fluid injected from the three directions collides at external collision point (P) to further atomize droplets.

### CITATION LIST

### Patent Literature

PTL 1: Unexamined Japanese Patent Publication No. 2010-127603

### SUMMARY OF THE INVENTION

An atomization device according to an aspect of the present invention includes a liquid flow path that supplies liquid, a gas flow path that supplies gas, and a atomization space in a cylindrical shape including: an upstream side to which a flow path downstream of the liquid flow path and a flow path downstream of the gas flow path are connected; and a downstream side from which droplets atomized by mixing the liquid and the gas in the atomization space are sprayed. The flow path downstream of the liquid flow path is connected to a central part of an end surface of the atomization space on the upstream side. The flow path downstream of the gas flow path is connected to a circumference around the central part of the end surface of the atomization space on the upstream side. The flow path downstream of the gas flow path has a central axis inclined from a central axis of the flow path downstream of the liquid flow path.

### BRIEF DESCRIPTION OF THE DRAWINGS

FIG. 1A is a schematic sectional end view of an atomization device according to an exemplary embodiment of the present invention.

FIG. 1B is an enlarged view of the schematic sectional end view of the atomization device according to the exemplary embodiment of the present invention.

FIG. 2 is an external perspective view of an atomization device according to an exemplary embodiment of the present invention.

FIG. 3 is a correlation diagram between diameter (d1) of liquid inflow path 31 and atomization characteristics.

FIG. 4 is a correlation diagram between diameter (d2) of atomization space 51 and atomization characteristics.

FIG. 5 is a correlation diagram between diameter (d1) of liquid inflow path 31 and diameter (d2) of atomization space 51, and atomization characteristics.

FIG. 6 is a correlation diagram between diameter (d2) of atomization space 51 and atomization characteristics.

FIG. 7 is a correlation diagram between an inflow angle of gas inflow path 40 with respect to atomization space 51 and atomization characteristics.

FIG. 8 is a schematic view of a conventional atomization device.

### DESCRIPTION OF EMBODIMENT

The conventional two-fluid nozzle of a suction type described in PTL 1 has a configuration with a problem that compressed air under high pressure is required to generate a liquid atomized to a particle size less than or equal to 10 m. Thus, when necessary pressure of compressed air for generating a particle of liquid with a size less than or equal to 10 m can be reduced, atomization can be performed by saved energy, and thus reducing a size and power consumption of a compressor that generates the compressed air and a size of an infrastructure to enable the liquid to be used for indoor space presentation, humidification, or chemical liquid spraying such as for sterilization or a pleasant aromatic odor.

Thus, the conventional technique has a problem of limiting a place of use of a nozzle or a use of the nozzle.

The present invention is made to solve the above problems, and an object of the present invention is to provide an atomization device capable of spraying a liquid having a particle with a small diameter using a two-fluid nozzle of a suction type and reducing pressure of compressed air.

Hereinafter, an exemplary embodiment of the present invention will be described with reference to the drawings.

The exemplary embodiment of the present invention relates to atomization device 10 that atomizes and sprays liquid using gas, and examples of the gas include air, nitrogen, oxygen, and an inert gas. The gas can be appropriately selected to be suitable for a purpose of use. Examples of the liquid include water, ozone water, a chemical solution having sterilization and disinfection functions, paint, and fuel oil. The liquid can be appropriately selected to be suitable for the purpose of use.

### Exemplary Embodiment

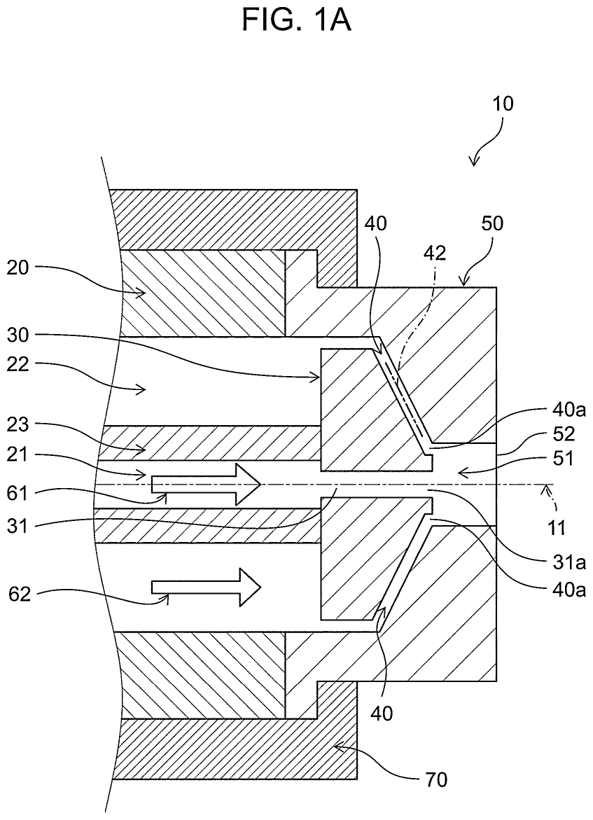

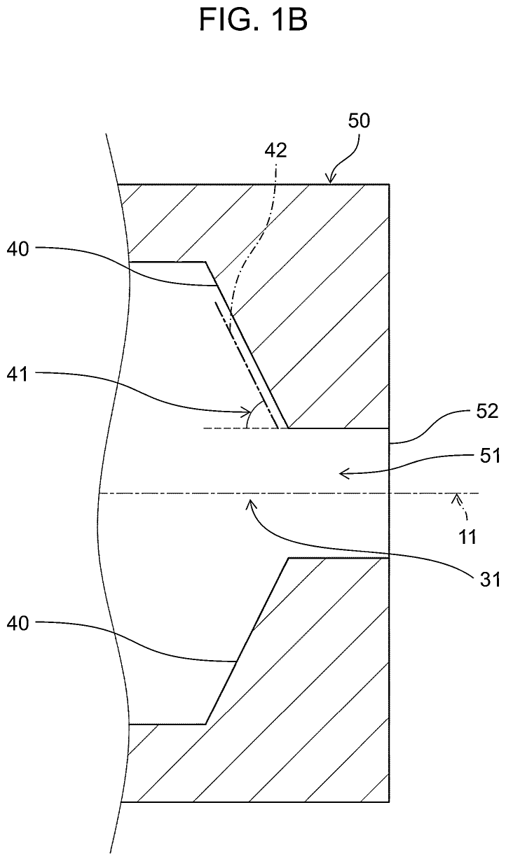

For description of an exemplary embodiment of the present invention, a configuration of atomization device 10 will be described first. FIG. 1A is a sectional view of atomization device 10 according to the exemplary embodiment of the present invention.

Atomization device 10 includes at least liquid flow path 21 for supplying liquid, gas flow path 22 for supplying gas, and atomization space 51 in a cylindrical shape including: a rear end part, i.e., a part on an upstream side to which flow path 31 downstream of liquid flow path 21 and flow path 40 downstream of gas flow path 22 are connected; and a downstream side from which droplets atomized by mixing the liquid and the gas in atomization space 51 are sprayed.

More specifically, atomization device 10 includes: at least atomization device body 20 including liquid flow path 21 and gas flow path 22; liquid introduction part 30 including liquid inflow path 31 downstream of liquid flow path 21; gas-liquid ejector 50; and gas inflow path 40 provided between liquid introduction part 30 and gas-liquid ejector 50 and located downstream of gas flow path 22. Gas-liquid ejector 50 includes atomization space 51 in a cylindrical shape. Atomization device 10 further includes atomization device fixture 70.

Atomization device body 20 is provided with liquid flow path 21 disposed along a direction of central axis 11 in a central part of a cylindrical member, and gas flow path 22 in a cylindrical shape disposed along the direction of central axis 11 across an interval around liquid flow path 21. Liquid flow path 21 and gas flow path 22 excluding downstream flow paths 31, 40, respectively, are separated from each other by cylindrical part 23 located in a central part of atomization device body 20 as a part of atomization device body 20 and located on central axis 11 of atomization device body 20. Liquid flow path 21 is illustrated with only near its distal end, i.e., a downstream side of liquid flow path 21 and near a part on the downstream side, and a liquid supply port (not illustrated) at a rear end, i.e., an upstream end is connected to a pump or the like connected to a liquid tank or the like with a water supply pipe, or is directly connected to a water pipe, for example. Gas flow path 22 is also illustrated with only near its distal end, i.e., a downstream side of gas flow path 22 and near a part on the downstream side, and a gas supply port (not illustrated) at a rear end, i.e., an upstream end is connected to a pneumatic source including an air compressor with a gas supply pipe, for example.

Cylindrical part 23 includes a downstream part that slightly protrudes from a distal end, i.e., a downstream side of atomization device body 20 other than cylindrical part 23, and liquid introduction part 30 is fixed to a distal end of cylindrical part 23.

Liquid introduction part 30 is a substantially truncated conical member disposed at the distal end of atomization device body 20 to cover a distal end opening of liquid flow path 21. Liquid introduction part 30 is provided with liquid inflow path 31 disposed downstream of liquid flow path 21 and passing through liquid introduction part 30 in a direction on central axis 11, and liquid inflow path 31 is provided at its downstream end with liquid inflow port 31a that communicates with atomization space 51.

Liquid inflow path 31 is composed of a hole passing through liquid introduction part 30 on the central axis 11, and liquid flow 61 flowing through liquid flow path 21 passes through the hole of liquid inflow path 31 and liquid inflow port 31a to flow into atomization space 51 in a cylindrical shape.

Gas inflow path 40 is formed upstream of atomization space 51 with a gap between an outer surface of liquid introduction part 30 and an inner surface of gas-liquid ejector 50. Gas inflow path 40 is provided at its downstream end with gas inflow port 40a that communicates with atomization space 51.

At least one gas inflow path 40 is disposed, and two gas inflow paths are disposed at an interval of 180 degrees, for example. Gas flow 62 flowing through gas inflow paths 40 atomizes liquid flow 61 in atomization space 51, liquid flow 61 flowing through liquid flow path 21 to flow through liquid inflow path 31, liquid inflow port 31a, and atomization space 51 in liquid introduction part 30.

Gas-liquid ejector 50 is disposed at the distal end of atomization device body 20 to cover not only atomization device body 20 and liquid introduction part 30 but also liquid flow path 21 and gas flow path 22, thereby forming gas inflow path 40 between atomization device body 20 and liquid introduction part 30. Liquid inflow port 31a of liquid inflow path 31 on a distal end side (i.e., a downstream side) of liquid flow path 21 is connected to a central part of an end surface of atomization space 51 on a rear end side (i.e., an upstream side). Gas inflow port 40a of gas inflow path 40 on a distal end side (i.e., a downstream side) of gas flow path 22 is connected on a circumference around the central part of the end surface of atomization space 51 on the rear end side (i.e., the upstream side). Gas inflow path 40 of gas flow path 22 has central axis 42 inclined from central axis 11 of liquid inflow path 31 of liquid flow path 21.

Although gas-liquid ejector 50 and liquid introduction part 30 are described as separate members, the present invention is not limited thereto, and gas-liquid ejector 50 and liquid introduction part 30 may be integrally formed as one member.

Atomization device fixture 70 is a cylindrical member, and sandwiches and fixes a flange part at an upstream end of gas-liquid ejector 50 with a downstream end surface of atomization device body 20. Gas-liquid ejector 50 may be directly fixed to the end surface of atomization device body 20 by eliminating atomization device fixture 70.

As illustrated in FIG. 1A, gas supplied to atomization device 10 in a configuration as described above flows through gas flow path 22 from a gas supply port (not illustrated) toward a distal end of the device in atomization device body 20 to form gas flow 62. Gas flow 62 passes through gas inflow path 40 and gas inflow port 40a to be supplied to atomization space 51, and is ejected from ejection port 52. At this time, negative pressure is generated in atomization space 51 by the flow of gas flow 62. The negative pressure generated in atomization space 51 causes liquid flow 61 in atomization device body 20 to passes through liquid flow path 21 from a liquid supply port (not illustrated), and further pass through liquid inflow path 31 and liquid inflow port 31a in liquid introduction part 30 to be supplied to atomization space 51. Gas flow 62 and liquid flow 61 supplied to atomization space 51 are mixed with each other in atomization space 51. After the liquid is atomized, the liquid mixed and atomized is ejected to the outside from ejection port 52 provided in gas-liquid ejector 50 and being an opening at a distal end of atomization space 51. FIG. 1B is an enlarged view of FIG. 1A, and gas flows into atomization space 51 from gas inflow path 40 with central axis 42 of gas inflow path 40 at an angle of gas inflow path angle 41 (i.e., a) with respect to central axis 11 of atomization space 51.

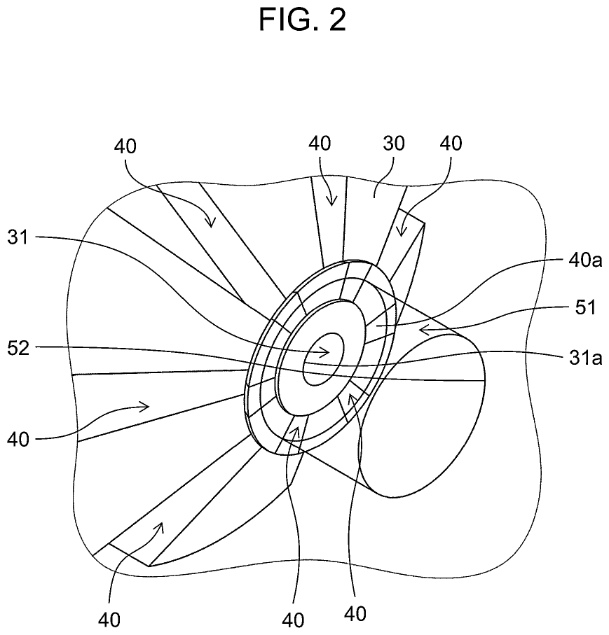

FIG. 2 is an external perspective view of a part of atomization device 10 and illustrates an example of placement of one liquid inflow path 31, a plurality of gas inflow paths 40, such as six gas inflow paths 31, disposed at equal intervals, and one atomization space 51.

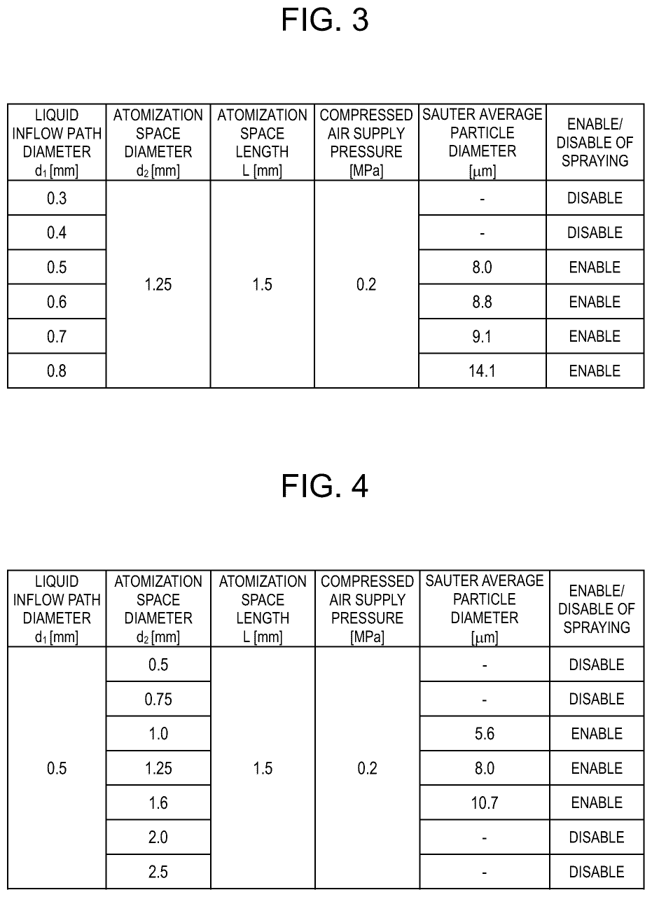

FIG. 3 shows one of characteristics of atomization device 10 in the present exemplary embodiment. Compressed air was used as an example of gas and water was used as an example of liquid. The Sauter average particle diameter was measured under conditions where atomization space 51 had diameter (d2) of 1.25 mm and axial length (L) of 1.5 mm, air was supplied under a pressure of 0.2 MPa, and liquid inflow paths 31 had respective diameters (d1) of 0.3 mm, 0.4 mm, 0.5 mm, 0.6 mm, 0.7 mm, and 0.8 mm. The Sauter average particle diameter of atomized water was evaluated by a laser diffraction method, and the laser diffraction method was performed with a measurement distance at a position of 100 mm from a distal end of atomization device 10.

The Sauter average particle diameter refers to a particle diameter having the same surface area to volume ratio as the total volume of all particles with respect to the total surface area of all particles. When there are nᵢ particles each having diameter dᵢ, the Sauter mean particle size (often denoted as D₃₂) is given by Expression below.

$${D}_{32} = \sum {n}_{i} {d}_{i}^{3} / \sum {n}_{i} {d}_{i}^{2}$$

Liquid inflow path 31 having diameter (d1) of 0.3 mm or 0.4 mm caused liquid inflow path 31 to have large pressure loss, so that water was unable to be sucked and sprayed. Liquid inflow path 31 having diameter (d1) of any one of 0.5 mm, 0.6 mm, 0.7 mm, and 0.8 mm enabled water to be sucked and sprayed. Liquid inflow path 31 having a large diameter causes a thick liquid column to be supplied to atomization space 51, and thus is disadvantageous for atomization. The following results were obtained.

0.5 mm>d1 . . . Liquid inflow path 31 had large pressure loss, so that water was unable to be sucked.

0.5 mm≤d1 . . . Negative pressure was formed in atomization space 51 to enable water to be sucked and atomized.

0.5 mm≤d1<0.8 mm . . . Negative pressure was formed in atomization space 51 to enable water to be sucked and sprayed, and to further enable atomization with a Sauter average particle diameter of 10 m. A liquid flow having a diameter (d1) of equal to or more than 0.8 mm caused the Sauter average particle diameter to exceed 10 m, so that sufficient atomization was unable to be performed.

The above results show that liquid inflow path 31 having diameter (d1) in the range of 0.5 mm≤d1<0.8 mm enables negative pressure to be generated in atomization space 51, and thus enables not only water to be sucked and sprayed, but also atomization with a Sauter average particle diameter of 10 m.

FIG. 4 shows one of characteristics of atomization device 10 in the present exemplary embodiment. Compressed air was used as an example of gas and water was used as an example of liquid. The Sauter average particle diameter was measured under conditions where liquid inflow path 31 had diameter (d1) of 0.5 mm, atomization space 51 had length (L) of 1.5 mm, air was supplied under a pressure of 0.2 MPa, and atomization spaces 51 had respective diameters (d2) of 0.5 mm, 0.75 mm, 1.0 mm, 1.25 mm, 1.6 mm, 2.0 mm, and 2.5 mm. The results are as follows.

1.0 mm>d2 . . . Atomization space 51 having thin diameter (d2) causes large pressure loss of compressed air, so that negative pressure was unable to be generated in atomization space 51 and water was unable to be sucked.

1.0 mm≤d2<2.0 mm . . . Negative pressure was generated in atomization space 51 to enable water to be sucked and sprayed.

2.0 mm≤d2 . . . Atomization space 51 having excessive large diameter (d2) diffused compressed air, so that negative pressure was unable to be generated in atomization space 51 and water was unable to be sucked.

The above results show that atomization space 51 having diameter (d2) in the range of 1.0 mm≤d2<2.0 mm enables negative pressure to be generated in atomization space 51, and thus enables not only water to be sucked and sprayed, but also atomization with a Sauter average particle diameter of 10 m.

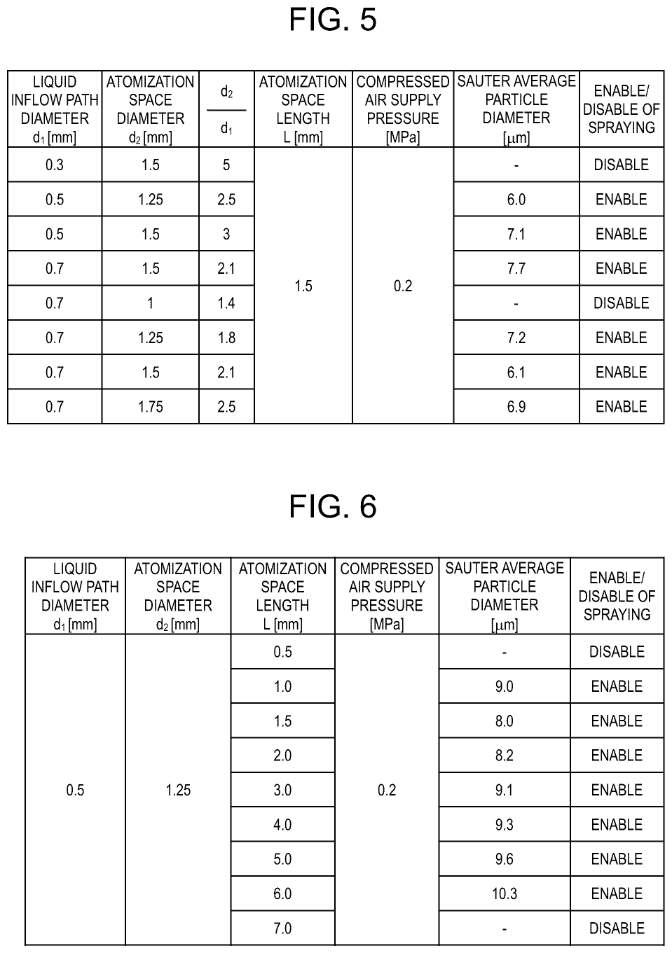

FIG. 5 shows one of characteristics of atomization device 10 in the present exemplary embodiment. Compressed air was used as an example of gas and water was used as an example of liquid. The Sauter average particle diameter was measured under conditions where atomization space 51 had length (L) of 1.5 mm, air was supplied under a pressure of 0.2 MPa, and values of diameter (d1) of liquid inflow path 31 and diameter (d2) of atomization space 51 were changed as shown in FIG. 5. The results are as follows.

1.4<d2/d1<5 . . . Negative pressure was able to be generated in atomization space 51 depending on a ratio between diameter (d1) of liquid inflow path 31 and diameter (d2) of atomization space 51.

The above results show that the ratio between diameter (d1) of liquid inflow path 31 and diameter (d2) of atomization space 51 in the range of 1.4<d2/d1<5 enables negative pressure to be generated in atomization space 51, and thus enables not only water to be sucked and sprayed, but also atomization with a Sauter average particle diameter of m.

FIG. 6 shows one of characteristics of atomization device 10 in the present exemplary embodiment. Compressed air was used as an example of gas and water was used as an example of liquid. The Sauter average particle diameter was measured under conditions where liquid inflow path 31 had diameter (d1) of 0.5 mm, atomization space 51 had diameter (d2) of 1.25 mm, air was suppled under a pressure of 0.2 MPa, and a value of length (L) of atomization space 51 was changed as shown in FIG. 6. The results are as follows.

1.0 mm>L . . . Atomization space 51 having short length (L) of less than 1.0 mm caused compressed air to immediately diffuse, so that negative pressure was unable to be formed in atomization space 51, and thus water was unable to be sucked and atomized.

1.0 mm≤L≤6.0 mm . . . Negative pressure was generated in atomization space 51 to enable not only water to be sucked and sprayed, but also atomization.

6.0 mm<L . . . Pressure loss in atomization space 51 increased to cause negative pressure to be unable to be formed in atomization space 51, and water to be unable to sucked.

The above results show that atomization space 51 having length (L) in a range from 1.0 mm to 6.0 mm inclusive enables negative pressure to be generated in atomization space 51, and thus enables not only water to be sucked and sprayed, but also atomization with a Sauter average particle diameter of 10 m.

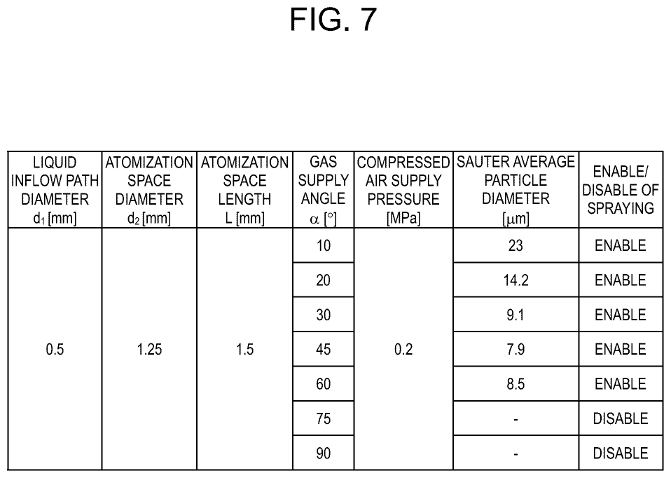

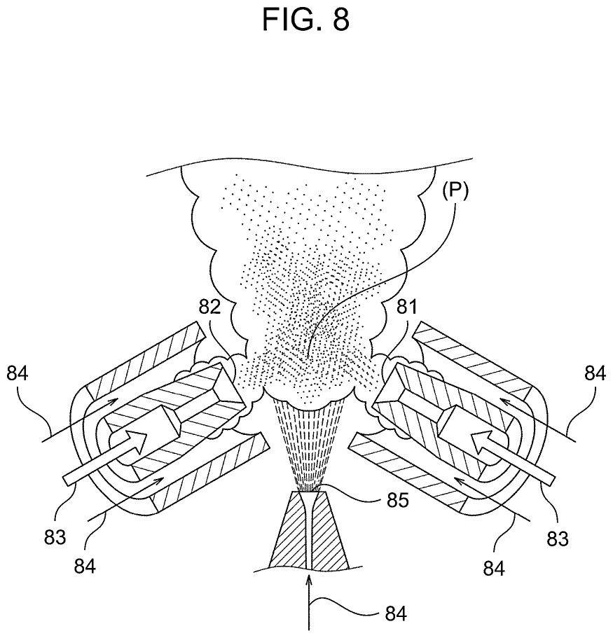

FIG. 7 shows one of characteristics of atomization device 10 in the present exemplary embodiment. Compressed air was used as an example of gas and water was used as an example of liquid. The Sauter average particle diameter was measured under conditions where liquid inflow path 31 had diameter (d1) of 0.5 mm, atomization space 51 had diameter (d2) of 1.25 mm and length (L) of 1.5 mm, air was supplied under a pressure of 0.2 MPa, and inflow angle (a) being gas inflow path angle 41 of gas inflow path 40 with respect to atomization space 51 was changed as shown in FIG. 7. The results are as follows.

0°<α≤20° . . . . Although negative pressure was formed in atomization space 51 to enable water to be sucked and atomized, the Sauter average particle diameter exceeded 10 m, and thus sufficient atomization was unable to be performed.

20°<α<75° . . . . Negative pressure was formed in atomization space 51 to enable water to be sucked and sprayed, and to further enable atomization with a Sauter average particle diameter of 10 m.

75°≤α≤90° . . . . Negative pressure was unable to be formed in atomization space 51, so that water was unable to be sucked.

The above results show that an angle of gas inflow path angle 41 in a range exceeding 20° and less than 75° with respect to atomization space 51 enables negative pressure to be generated in atomization space 51, and thus enables not only water to be sucked and sprayed, but also atomization with a Sauter average particle diameter of 10 am.

As described above, atomization device 10 according to the present exemplary embodiment is configured as follows: flow path 31 downstream of liquid flow path 21 is connected to the central part of the end surface of atomization space 51 on the upstream side; flow path 40 downstream of gas flow path 22 is connected to the circumference around the central part of the end surface of atomization space 51 on the upstream side; and flow path 40 downstream of gas flow path 22 has central axis 42 inclined from central axis 11 of flow path 31 downstream of liquid flow path 21. As a result, a liquid having a small particle size (e.g., a particle size of less than or equal to 10 m) can be sprayed with the two-fluid nozzle of a suction type, and pressure of the compressed air can be reduced.

When any exemplary embodiments or modifications are appropriately combined in the various exemplary embodiments or modifications described above, the effect possessed by each of them can be achieved. Additionally, the exemplary embodiments can be combined with each other, and the examples can be combined with each other, and then features in the different exemplary embodiments, or in the different examples, also can be combined with each other.

As described above, atomization device according to the above aspect is configured as follows: the flow path downstream of the liquid flow path is connected to the central part of the end surface of the atomization space on the upstream side; the flow path downstream of the gas flow path is connected to the circumference around the central part of the end surface of the atomization space on the upstream side; and the flow path downstream of the gas flow path has a central axis inclined from a central axis of the flow path downstream of the liquid flow path. As a result, a liquid having a small particle size (e.g., a particle size of less than or equal to 10 m) can be sprayed with the two-fluid nozzle of a suction type, and pressure of the compressed air can be reduced.

### INDUSTRIAL APPLICABILITY

The atomization device according to the above aspect of the present invention is capable of atomizing a liquid without pressurizing the liquid and spraying the atomized liquid with compressed air under low pressure, and the atomization device can be widely used for cooling, humidification, chemical liquid spraying such as for sterilization or a pleasant aromatic odor, space presentation, combustion, dust countermeasures, and the like, for a space or a substance.

### REFERENCE MARKS IN THE DRAWINGS

10 atomization device
11 central axis
20 atomization device body
21 liquid flow path
22 gas flow path
23 cylindrical part
30 liquid introduction part
31 liquid inflow path
31a liquid inflow port
40 gas inflow path
40a gas inflow port
41 gas inflow path angle
42 central axis of gas inflow path
50 gas-liquid ejector
51 atomization space
52 ejection port
61 liquid flow
62 gas flow
70 atomization device fixture
81 second injection port
82 third injection port
83 water
84 compressed air
85 first injection port

1. An atomization device comprising:
a liquid flow path that supplies liquid;
a gas flow path that supplies gas; and
an atomization space in a cylindrical shape,
the atomization space including:
an upstream side to which a flow path downstream of the liquid flow path and a flow path downstream of the gas flow path are connected; and
a downstream side from which droplets atomized by mixing the liquid and the gas in the atomization space are sprayed,
wherein
the flow path downstream of the liquid flow path is connected to a central part of an end surface of the atomization space on the upstream side,
the flow path downstream of the gas flow path is connected to a circumference around the central part of the end surface of the atomization space on the upstream side, and
the flow path downstream of the gas flow path has a central axis inclined from a central axis of the flow path downstream of the liquid flow path.

2. The atomization device according to claim 1, wherein
the flow path downstream of the liquid flow path has a diameter d1 satisfying a relationship of 0.5 mm≤d1<0.8 mm,
the diameter d1 of the flow path downstream of the liquid flow path has a relationship with a diameter d2 of the atomization space, the relationship satisfying 1.4<d2/d1<5, and
the atomization space has a length L satisfying a relationship of 1.0 mm≤L≤6.0 mm.

3. The atomization device according to claim 2, wherein the central axis of the flow path downstream of the gas flow path forms an inflow angle α with the central axis of the atomization space, serving as the central axis of the flow path downstream of the liquid flow path, the inflow angle α satisfying a relationship of 20°<α<75°.
